(19) United States
(12) Patent Application Publication
(10) Pub. No.: US 2025/0295169 A1
(43) Pub. Date: Sep. 25, 2025

(54) HEATER ASSEMBLY AND METHOD

(71) Applicant: NICOVENTURES TRADING LIMITED, London (GB)

(72) Inventor: David LEADLEY, London (GB)

(21) Appl. No.: 18/860,142

(22) PCT Filed: Apr. 26, 2023
(86) PCT No.: PCT/GB2023/051100

§ 371 Date: Oct. 25, 2024

(30) Foreign Application Priority Data
Apr. 28, 2022 (GB) 2206234.3

(51) Int. Cl. A24F 40/46; A24F 40/10; A24F 40/44; A24F 40/48; A24F 40/70; H05B 3/26

(52) U.S. Cl. CPC A24F 40/46; A24F 40/10; A24F 40/44; A24F 40/48; A24F 40/70; H05B 3/265; H05B 2203/013; H05B 2203/021

(57) ABSTRACT

A is a heater assembly for an aerosol provision system, the heater assembly including a substrate; an electrically resistive layer provided on a first surface of the substrate; and one or more capillary tubes extending from another surface of the substrate through the electrically resistive layer provided on the first surface of the substrate. The one or more capillary tubes extend substantially linearly from the another surface of the substrate through the electrically resistive layer provided on the first surface of the substrate, and the substrate additionally includes a porous region. Also described is a cartomizer including a heater assembly, an aerosol provision system comprising a heater assembly, and a method of manufacturing a heater assembly.

### RELATED APPLICATIONS

The present application is a National Phase entry of PCT Application No. PCT/GB2023/051100 filed Apr. 26, 2023, which claims priority to GB Application No. 2206234.3 filed Apr. 28, 2022, each of which is hereby incorporated by reference in their entirety.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporization. An aerosol source for an aerosol provision system may thus comprise a heater having a heating element arranged to receive source liquid from the reservoir, for example through wicking/capillary action. While a user inhales on the device, electrical power is supplied to the heating element to vaporize source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Typically, such aerosol provision systems are provided with heater assemblies suitable for heating the source liquid to form an aerosol. However, conventional heater assemblies do not necessarily provide an efficient liquid supply to the heater element of the heater assembly in various circumstances, particularly when the aerosol provision system is held at a different orientation.

Various approaches are described which seek to help address some of these issues.

### SUMMARY

According to a first aspect of certain embodiments there is provided a heater assembly for an aerosol provision system, the heater assembly including a substrate; an electrically resistive layer provided on a first surface of the substrate; and one or more capillary tubes extending from another surface of the substrate through the electrically resistive layer provided on the first surface of the substrate. The one or more capillary tubes extend substantially linearly from the another surface of the substrate through the electrically resistive layer provided on the first surface of the substrate. The substrate additionally comprises a porous region.

According to a second aspect of certain embodiments there is provided a cartomizer for use with an aerosol-generating device for generating aerosol from an aerosol-generating material, the cartomizer including a reservoir for storing aerosol-generating material, and a heater assembly according to the first aspect, wherein the heater assembly is provided in fluid communication with the reservoir.

According to a third aspect of certain embodiments there is provided an aerosol provision system for generating aerosol from an aerosol-generating material, the aerosol provision system comprising the heater assembly of the first aspect.

According to a fourth aspect of certain embodiments there is provided a method of manufacturing a heater assembly for an aerosol provision system, the method including providing a substrate comprising an electrically resistive layer provided on a first surface of the substrate; and forming one or more capillary tubes extending from another surface of the substrate through the electrically resistive layer provided on the first surface of the substrate. The one or more capillary tubes extend substantially linearly from the another surface of the substrate through the electrically resistive layer provided on the first surface of the substrate, and the substrate additionally comprises a porous region.

According to a fifth aspect of certain embodiments there is provided heater means for an aerosol provision system, the heater means including: a substrate; an electrically resistive layer provided on a first surface of the substrate; and capillary means extending from another surface of the substrate through the electrically resistive layer provided on the first surface of the substrate. The capillary means extend substantially linearly from the another surface of the substrate through the electrically resistive layer provided on the first surface of the substrate. The substrate additionally comprises a porous region.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a perspective view of an aerosol provision system in accordance with aspects of the present disclosure;

FIG. 2 is an exploded perspective view of a cartomizer suitable for use in the aerosol provision system of FIG. 1;

FIG. 3 is a perspective view of a first heater assembly in accordance with aspects of the present disclosure, wherein the heater assembly comprises a substrate having a porous region, an electrically resistive layer, and capillary tubes extending through the substrate and electrically resistive layer;

FIG. 4 is a perspective view of a second heater assembly in accordance with aspects of the present disclosure, wherein the heater assembly is coupled to electrically conductive contact elements;

FIG. 5 is a perspective view of a third heater assembly in accordance with aspects of the present disclosure, wherein the substrate is provided with electrically conductive elements; and

FIG. 6 is a method in accordance with aspects of the present disclosure for forming heater assemblies.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device, electronic cigarette or electronic nicotine delivery system (END), although it is noted that the presence of nicotine in the aerosol-generating material is not a requirement. Throughout the following description the term “e-cigarette” is sometimes used but this term may be used interchangeably with aerosol (vapor) provision system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

In some embodiments, the or each aerosol-generating material may comprise one or more active constituents, one or more flavors, one or more aerosol-former materials, and/or one or more other functional materials.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a mouthpiece, and/or an aerosol-modifying agent.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

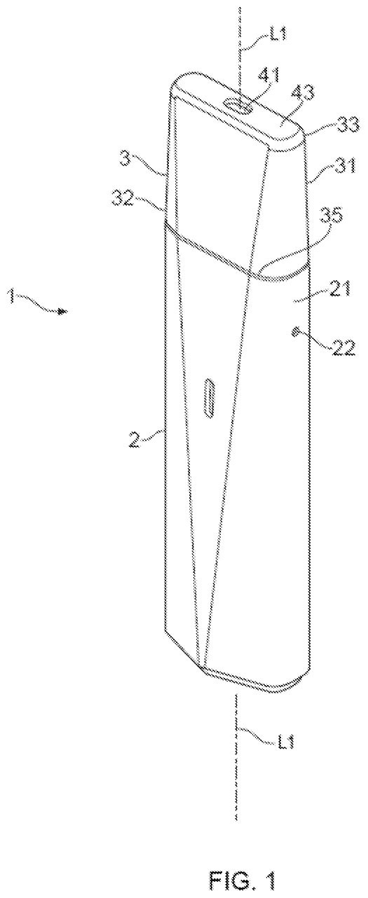

FIG. 1 shows an aerosol provision system 1 comprising an aerosol provision device 2 and a consumable 3, herein shown and referred to as a cartomizer 3. The cartomizer 3 is configured to engage and disengage with the aerosol provision device 2. That is, the cartomizer 3 is releasably connected/connectable to the aerosol provision device 2. More specifically, the cartomizer 3 is configured to engage/disengage with the aerosol provision device 2 along the longitudinal axis L1. The cartomizer 3 and aerosol provision device 2 are provided with suitable interfaces to allow the cartomizer 3 and aerosol provision device 2 to engage/disengage from one another, e.g., a push fit interface, a screwthread interface, etc.

The cartomizer 3 comprises a reservoir which stores an aerosol-generating material. In the following, the aerosol-generating material is a liquid aerosol-generating material. The liquid aerosol-generating material (herein sometimes referred to as liquid) may be a conventional e-liquid which may or may not contain nicotine. However, other liquids and/or aerosol generating materials may be used in accordance with the principles of the present disclosure. The cartomizer 3 is able to be removed from the aerosol provision device 2 when, for example, the cartomizer 3 requires refilling with liquid or replacement with another (full) cartomizer 3.

The aerosol provision device 2 comprises a power source (such as a rechargeable battery) and control electronics. As will be described below, the cartomizer 3 comprises an electrically powered heater assembly. When the cartomizer 3 is coupled to the aerosol provision device 2, the control electronics is configured to supply electrical power to the heater assembly of the cartomizer 3 to cause the heater assembly to generate an aerosol from the liquid aerosol-generating material. The control electronics may be provided with various components to facilitate/control the supply of power to the cartomizer 3. For example, the control electronics may be provided with an airflow sensor configured to detect when a user of the aerosol provision system 1 inhales on the aerosol provision system and to supply power in response to such a detection and/or a push button which is pressed by the user and to supply power in response to such a detection. However, it should be understood that additional functions may be controlled by the control electronics depending on the configuration of the aerosol provision device 2 (for example, the control electronics may be configured to control/regulate recharging of the power source, or to facilitate wireless communication with another electronic device, such as a smartphone). The features and functions of the aerosol provision device 2 are not of primary significance in respect of the present disclosure.

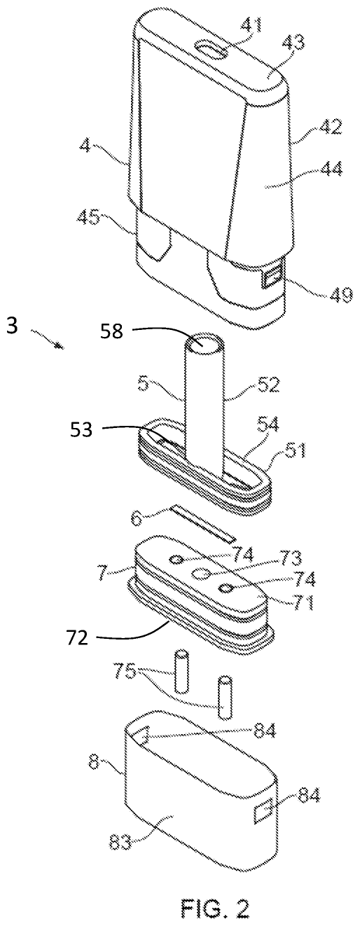

FIG. 2 show an example cartomizer 3 suitable for use in the aerosol provision system of FIG. 1. From the exploded view of FIG. 2, it may be seen that the cartomizer 3 is assembled from a stack of components: an outer housing 4, an upper clamping unit 5, a heater assembly 6, a lower support unit 7 and an end cap 8.

The cartomizer 3 has a top end 31 and a bottom end 32 which are spaced apart along the longitudinal axis L1, which is the longitudinal axis of the cartomizer as well as being the longitudinal axis of the aerosol provision system 1. The top end 31 of the cartomizer defines a mouthpiece end of the aerosol provision system 1 (on which a user may place their mouth and inhale), and the mouthpiece 33 includes a mouthpiece orifice 41 which is provided at the top end 42 of outer housing 4 in the center of a top face 43.

The outer housing 4 includes a circumferential side wall 44 which leads down from the top end 42 to a bottom end 45 of the outer housing 4 and which defines an internal reservoir 46 for holding the liquid aerosol-generating material. Prior to assembly of the cartomizer 3, the bottom end 45 of the outer housing is open, but upon assembly the bottom end 45 is closed by a plug formed by the upper clamping unit 5 and the lower support unit 7 which are stacked together with the heater assembly 6 sandwiched therebetween.

The upper clamping unit 5 is an intermediate component of the stack of components. The upper clamping unit 5 includes a foot 51 in the form of a block and an upwardly extending air tube 52. On each side of the air tube 52, the foot 51 includes a well 53 which descends from a flat top surface 54 to a flat bottom surface (not shown in FIG. 2) of the foot 51. At the bottom surface, each well 53 is open and, specifically, opens into an elongate recess formed in the bottom surface, with the depth of the recess broadly matching the size/shape and thickness of the heater assembly 6. The foot 51 is designed to engage with the outer housing 4 (more specifically, such that the outer circumferential surface of the foot is pressed against an inner circumferential surface of the outer housing 4). The foot 51 may have a suitable shape and include suitable sealing components to reduce or prevent liquid from leaking between the outer surface of the foot 51 and the inner surface of the housing 4.

The air tube 52 extends up from the bottom of the wells 53 and defines an internal air passage 58. When the upper clamping unit 5 is engaged with the outer housing 4, the air tube 52 extends up to and encircles the mouthpiece orifice 41. The outer housing 4 and/or the air tube 52 may be suitably configured so as to provide a liquid-(and optionally air-) tight seal between the two. As will be understood below, air/aerosol is intended to pass along the air tube 52 and out of the mouthpiece orifice 41, while the space around the air tube 52 and within the outer housing 4 defines the reservoir 46 for storing the liquid aerosol-generating material. Hence, it should be understood that, with the exception of the openings of the wells 53, the reservoir 46 is a sealed volume defined by the outer housing 4, the outer surface of the air tube 52, and the foot 51.

The lower support unit 7 is in the form of a block having a broadly flat top surface 71 and a flat bottom surface 72. A central air passage 73 extends upwardly from the bottom surface 72 to the top surface 71. On each side of the air passage 73, the block of the lower support unit 7 includes a through hole 74. In the example cartomizer 3 of FIG. 2, a co-moulded contact pad 75 in the form of a pin is inserted into the through holes 74. More specifically, each contact pad 75 is a press fit in its respective through hole 74. Each contact pad 75 provides an electrical connection path from the bottom surface 72 to a respective end portion of the heater assembly 6 when the heater assembly 6 is sandwiched between the top surface 71 of the lower support unit 7 and the recess of the bottom surface 55 of the upper clamping unit 5.

Much like the upper clamping unit 5, the lower support unit 7 is designed to engage with the outer housing 4 (more specifically, such that the outer circumferential surface of the lower support unit 7 is pressed against an inner circumferential surface of the outer housing 4). The lower support unit 7 may have a suitable shape and include suitable sealing components to reduce or prevent liquid from leaking between the outer surface of the lower support unit 7 and the inner surface of the housing 4. The foot 51 of the upper clamping unit 5 and the lower support unit 7 (with its block-like form) combine together to form a plug which seals the bottom end of the reservoir 46.

As shown in FIG. 2, the cartomizer 3 includes an end cap 8 at its bottom end. The end cap 8 is made of metal and serves to assist with retaining the cartomizer 3 in the aerosol provision device 2 when the cartomizer 3 is plugged in to the top end of the aerosol provision device 2, because, in this example, the aerosol provision device 2 is provided with magnets which are attracted to the metal of the end cap 8. The end cap 8 has a bottom wall 81 with a central opening (not shown in FIG. 2). The end cap 8 also has a circumferential side wall 83 which has two opposed cut-outs 84 which latch onto corresponding projections 49 on the outer surface of the bottom end of the side wall 44 of the outer housing 4, so that the end cap 8 has a snap-fit type connection onto the bottom end of the outer housing 4. When the end cap 8 has been fitted in position, it holds in position the lower support unit 7, the upper clamping unit 5 and the heater assembly 6 which is sandwiched between the lower support unit 7 and the upper clamping unit 5.

It would be possible to omit the end cap 8 (in order to reduce the component count) by arranging for the lower support unit 7 to form a snap-fit type connection with the bottom end of the side wall 44 of the outer housing 4. Additionally, the cartomizer 3 could be provided with indentations which engage with projections at the top end 21 of the main housing 2, so that a releasable connection is provided between the cartomizer and the main housing.

In any case, the cartomizer 3 is provided what may more generally be referred to as a device interface which is a part of the cartomizer 3 that interfaces with the main housing 2 (or aerosol-generating device). In the above example, the device interface may include the metal cap 8 including the bottom wall 81 and circumferential side wall 83 and/or the lower support unit 7 including the bottom surface 72. More generally, the device interface of the cartomizer 3 may encompass any part or parts of the cartomizer 3 that contact, abut, engage or otherwise couple to the main housing 2.

When the components of the cartomizer 3 have been assembled together, an overall air passage exists from the bottom end 32 to the top end 31 of the cartomizer 3 and it is formed by the air passage 73 leading to the air passage 58 which, in turn, leads to the mouthpiece orifice 41. Where the air passage 73 meets the air passage 58, the air flow bifurcates as it passes around the side edges of the heater assembly 6.

With reference back to FIG. 1, the top end 21 of the aerosol provision device 2 includes an air inlet hole 22 on each side of the aerosol provision device 2 (with one of the two air inlet holes 22 being visible in FIG. 1). Air can enter the air inlet holes 22 and flow transversely inwards to the longitudinal axis L1 so as to enter the bottom end of the air passage 73 of the lower support unit 7 and to start to flow in the direction of the longitudinal axis L1 towards the mouthpiece 33.

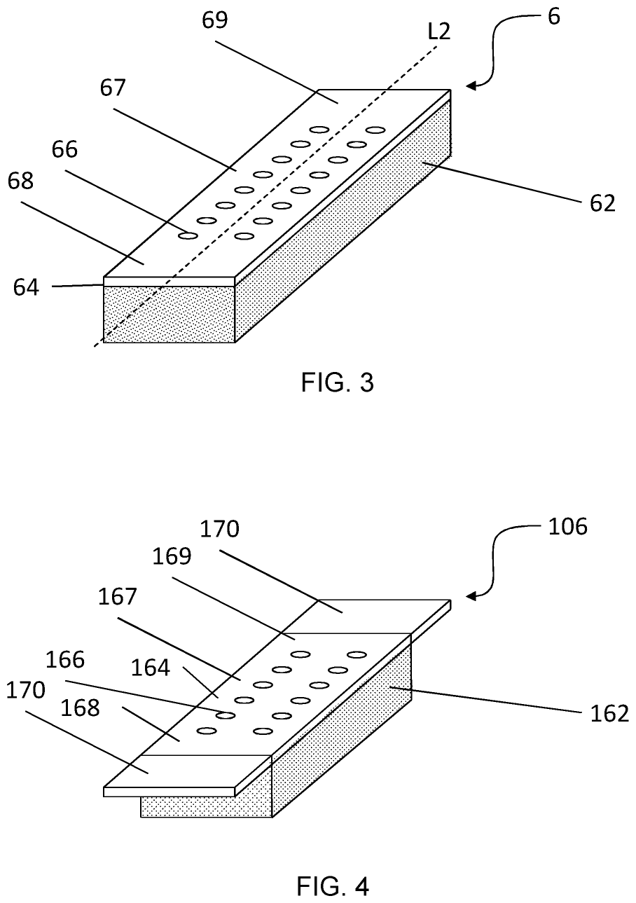

Turning now to the heater assembly 6, the heater assembly 6 is a microfluidic heater assembly. FIG. 3 illustrates the microfluidic heater assembly 6 in more detail.

The microfluidic heater assembly 6 comprises a substrate 62 and an electrically resistive layer 64 disposed on a surface of the substrate 62.

In this implementation, the substrate 62 is formed from a non-conductive material, such as quartz (silicon dioxide); however, it should be appreciated that other suitable non-conductive materials may be used, such as ceramics or silicon oxide, for example. The electrically resistive layer 64 is formed form any suitable electrically conductive material, for example a metal or a metal alloy such as titanium or nickel chromium.

The heater assembly 6 is planar and in the form of a cuboidal block, elongate in the direction of a longitudinal axis L2. The heater assembly 6 has the shape of a strip and has parallel sides. The planar heater assembly 6 has parallel upper and lower major (planar) surfaces and parallel side surfaces and parallel end surfaces. In the shown implementation of FIG. 3, the length of the heater assembly 6 is 10 mm, its width is 1 mm, and its thickness is 0.12 mm. The small size of the heater assembly 6 enables the overall size of the cartomizer to be reduced and the overall mass of the components of the cartomizer to be reduced. However, it should be appreciated that in other implementations, the heater assembly 6 may have different dimensions depending upon the application at hand. For example, in some implementations, the heater assembly 6 may be a 3×3 mm chip.

Along the longitudinal axis L2, the heater assembly 6 has a central portion 67 and first and second end portions 68, 69. In FIG. 3, the length of the central portion 67 (relative to the lengths of the end portions 68, 69) has been exaggerated for reasons of visual clarity. When the vaporizer is in situ in the cartomizer, the central portion 67 is positioned in the air passage 34. The central portion 67 extends across the top end of the air passage 73 of the lower support unit 7, and across the bottom end of the air passage 58 of the upper clamping unit 5. The end portions 68, 69 are clamped between the upper clamping unit 5 and the lower support unit 4.

In the central portion 67 of the heater assembly 6, a plurality of capillary tubes 66 are provided. Only the openings of the capillary tubes 66 are shown in FIG. 3 (and in an exaggerated way for clarity), but the capillary tubes 66 extend from one side of the heater assembly 6 to the other. More specifically, the capillary tubes extend from the side of the heater assembly 6 opposite the electrically resistive layer 64 (the largest surface not shown in FIG. 3), through the substrate 62 toward the face of the substrate 62 on which the electrically resistive layer 64 is disposed, and then through the electrically resistive layer 64. The plurality of capillary tubes 66 extend substantially linearly through the heater assembly 6 (that is, the capillary tubes 66 follow substantially linear paths). By substantially, it is meant that the capillary tubes 66 follow pathways that are within 5%, within 2% or within 1% of a straight line. The capillary tubes 66 are formed in the heater assembly 66 via a manufacturing process. That is to say, the capillary tubes 66 do not naturally exist in the substrate material 62 or electrically resistive layer 64, but rather, the capillary tubes 66 are formed in the substrate material 62 and electrically resistive layer 64 through a suitable process. A suitable process for forming the capillary tubes 66, particularly when forming capillary tubes that substantially follow a linear path, is laser drilling. However, any other suitable technique may be employed in order to generate the capillary tubes 66.

The capillary tubes 66 are configured so as to transport liquid from one surface of the heater assembly 6 (i.e., the surface opposite the electrically resistive layer 64) to the electrically resistive layer 64. The exact dimensions of the capillary tubes 66, and in particular the diameter, may be set in accordance with the liquid to be stored in the reservoir 46 of the cartomizer 3 and subsequently used with the heater assembly 6. For example, the properties of the liquid aerosol-generating material (e.g., viscosity) in the reservoir 46 of the cartomizer 3 may dictate the diameter of the capillary tubes 66 to ensure that a suitable flow of liquid is provided to the electrically resistive layer 64. However, in some implementations, the capillary tubes 66 may have a diameter on the order to tens of microns, e.g., between 10 μm to 100 μm. However, it should be appreciated that capillary tubes 66 in other implementations may be set differently based on the properties of the liquid to be vaporized and/or a desired supply of liquid to the electrically resistive layer 64. Moreover, it should be appreciated that to achieve a desired level of flow to the electrically resistive layer 64, not only the diameter of the capillary tubes 66 but also the number/number per unit area of the capillary tubes 66 may also influence the supply of liquid to the electrically resistive layer 64.

In addition, the substrate 62 of the heater assembly 6 comprises a porous region. More specifically, in the example shown, the porous region is the entire substrate 62. However, it should be appreciated that in other implementations, the porous region may only comprise a part of the substrate 62.

The porous region is different from the capillary tubes 66 in that the porous region is arranged so as to comprise a plurality of interconnected pores (voids) defining passages that follow a substantially random pathway through the porous region of the substrate 62. In this regard, unlike the capillary tubes 66 where liquid passing along the capillary tubes 66 flows substantially in a fixed direction (i.e., along the capillary tube 66), liquid within the porous region may flow along substantially any direction owing to the more random arrangement of the interconnected pores (voids). While it should be appreciated that the arrangement of the interconnected pores/voids may not be entirely random (for example, some materials may exhibit a structured and uniform arrangement of the pores), the actual directions that liquid may flow within the porous region is substantially more random than in the capillary tubes 66 owing to the various ways in which the interconnected pores may be interconnected.

The porous region may be formed from naturally porous materials, such as sponges, porous stones or ceramics etc., or via materials that are engineered to be porous, such as sintered metals or other materials. These materials, either formed naturally or engineered, have pores or hollow regions which are interconnected and define passages that follow a substantially random pathway through the material. In the example of FIG. 3, the substrate 62 is formed from a sintered material, and in particular, a sintered quartz (silicon dioxide). Sintering is the process of providing a powdered or granule material (e.g., quartz), and heating and/or compacting (e.g., via applying a pressure) the powdered or granule material to form a bulk material. Depending on the material to be sintered and the desired properties (such as porosity or average pore sizes) for the bulk material, the powdered material may be subjected to suitable temperatures and suitable pressures to yield the desired bulk material having the desired characteristics.

As should be appreciated, the capillary tubes 66 of the heater assembly 6 are shown as extending through the porous region of the substrate 62. In this regard, the capillary tubes 66 can be thought of as intercepting ones of the random passages defined by the interconnected pores of the porous region. The random passages can therefore be considered to feed into the capillary tubes 66 (and as will be explained later, liquid transported along the random passages is delivered to the capillary tubes 66, for subsequent transport to the electrically resistive layer 64). The porous region of the substrate 62 also exhibits different properties with respect to the capillary tubes 66—for example, the porosity in the porous region may be different to the porosity of the porous region. As will be explained below, the capillary tubes 66 are for providing a direct pathway for liquid to the electrically resistive layer 64, while the porous region is provided to facilitate the supply of liquid to the capillary tubes 66. It should be appreciated that the capillary tubes 66 do not necessarily need to extend through the porous region, but instead may be provided adjacent to the porous region provided that liquid is capable of being delivered to the capillary tubes 66 from the porous region.

With reference back to FIG. 2, the heater assembly 6 is shown positioned between the upper clamping unit 5 and the lower support unit 7. In particular, the heater assembly 6 is oriented such that the electrically resistive layer 64 faces towards the lower support unit 7, while the sintered substrate 62 faces towards the upper clamping unit 5.

It should be understood from FIG. 2 that the end portions 68, 69 of the heater assembly 6 overlap the through holes 74 and the contact pads 75. More specifically, the electrically resistive layer 64 is provided in contact with the contact pads 75, and therefore the end portions 68, 69 act to form an electrical connection with the contact pads 75 (and thus any power source subsequently attached to the contact pads 75, such as from the aerosol provision device 2). For example, the aerosol provision device 2 may have two power supply pins (not shown) which make contact with the bottom ends of the contact pads 75. The top ends of the contact pads 75 are in electrical contact with the heater assembly 6, as above. In use, electrical power supplied by the power supply of the aerosol provision device 2 passes through the electrically resistive layer 64, by virtue of the electrical connection between the end portions 68, 69 and the contact pads 75, to cause heating of the electrically resistive layer 64. The amount of heating achieved (i.e., the temperature of the electrically resistive layer 64 that is able to be reached) may depend on the power supplied by the aerosol provision device 2 and the electrical resistance of the electrically resistive layer 64. Equally, the amount of heating required (i.e., the temperature necessary to vaporize the liquid supplied to the resistive layer 64) will be dependent in part on the properties of the liquid supplied to the electrically resistive layer 64. Accordingly, the resistance of the electrically resistive layer 64 may be set based on the particular application at hand, whereby the resistance of the electrically resistive layer 64 may be dependent on the material of the electrically resistive layer 64 and the physical dimensions of the electrically resistive layer 64 (e.g., thickness).

In addition, the end portions 68, 69 are also configured to receive liquid from the reservoir 46 from above, by virtue of being positioned beneath the wells 53 of the upper clamping unit 5. In this regard, the sintered substrate 62 is positioned in fluid communication with the wells 53 and hence the liquid stored in the reservoir 46 of the cartomizer 3. Assuming the sintered substrate 62 is provided with a suitable porosity/pore size for the properties of the liquid stored in the reservoir 46, the sintered substrate 62 is configured to absorb liquid from the reservoir 46. In this regard, the pore size (or average pore size) of the sintered substrate 62 may be selected to be in the range of 1 μm to 100 μm in order to provide suitable absorption for conventional e-liquids, although it should be appreciated that the exact (average) pore size may be different in different implementations.

The substrate 62 is configured to provide liquid to the capillary tubes 66 of the heater assembly 6. That is, liquid which is absorbed by the porous region of the substrate 62 from wells 53 is able to travel from the end portions 68, 69 of the substrate 62 towards the central portion 67 of the heater assembly 6. Accordingly, when the liquid reaches the center portion 67 of the heater assembly 6, some of the pathways through the porous region of the substrate 62 arrive at/terminate at one of the capillary tubes 66. Liquid flowing along these pathways is subsequently provided to the capillary tubes 66. That is to say, the function of the porous region of the substrate 62 is to help feed liquid to the capillary tubes 66 of the heater assembly, wherein the capillary tubes 66 provide a more direct pathway (i.e., a pathway having a shorter distance) to the part of the heater assembly responsible for vaporizing the liquid to form an aerosol (i.e., the electrically resistive layer 64).

The configuration of the cartomizer 3 shown in FIG. 3 is one where the vaporization of liquid occurs in a certain region of the heater assembly 6; namely, the center portion 67 of the heater assembly 6. The end portions 68, 69 of the heater assembly 6 are not especially suited for vaporizing liquid, firstly because these end portions 68, 69 are not provided with capillary tubes 66 extending through to the electrically resistive layer 64 in these portions, and secondly because the contact pads 75 contact a part of the surface of the electrically resistive layer 64 at the end portions 68, 69. Accordingly, in one aspect, the porous region of the substrate 62 is provided to facilitate lateral/horizontal movement of the liquid from the end portions 68, 69 to the center portion 67 of the heating assembly 6.

However, the porous region of the substrate 62 also acts to retain a volume of liquid which can be supplied to the electrically resistive layer 64 even when the heater assembly 6 is no longer in fluid contact with the liquid in the reservoir 46. For example, with reference to FIGS. 1 and 2, these Figures show the aerosol provision system 1 held in what would be considered a substantially normal position when using the aerosol provision system 1. That is to say, during normal use, the user would typically orient the base of the aerosol provision device 2 (the part opposite the cartomizer 3) downwards or substantially downwards, while the mouthpiece 33 is oriented upwards or substantially upwards. In such arrangements, the liquid held in the reservoir 46 sits in the wells 53 and is therefore in fluid contact with the end portions 68, 69 of the heater assembly 6. However, when the aerosol provision system 1 is inverted (or the base of the aerosol provision device 2 is held relatively higher than the mouthpiece 33), the liquid within the reservoir 46 may sit at the opposite end of the reservoir 46 (i.e. away from the wells 53). In this case, the liquid in the reservoir 46 is not in fluid contact with the end portions 68, 69 of the heater assembly 6. However, because the porous region of the substrate 62 is configured to absorb liquid from the liquid reservoir 46, when the liquid in the reservoir 46 is no longer in fluid contact with the end portions 68, 69 of the heater assembly 6, the heater assembly 6 (and more particularly the porous region of the substrate 62) retains a volume of liquid. Even when the liquid in the reservoir 46 is not in fluid contact with the heater assembly 6, the heater assembly 6 can still provide liquid to the capillary tubes 66 of the heater assembly 6 (and thus to the electrically resistive layer 64). While the available volume of liquid in such instances may be significantly less that the volume of liquid stored in the reservoir 46, the volume of liquid that is retained in the porous region of the substrate may be sufficient to provide for several inhalations, thus providing continuous use in the event of temporary orientation changes of the aerosol provision system 1.

Hence, as stated above, the porous region of the substrate 62 is configured to provide liquid to the capillary tubes 66 of the heater assembly 6, and this may be to facilitate transfer of liquid to areas of the heater assembly 6 that are adapted to generate and release aerosol from vaporized liquid (e.g., the central portion 67) or it may be to store liquid such that liquid may be provided to the electrically resistive layer 64 of the heater assembly 6 even when the heater assembly is not in fluid contact with the liquid stored in the reservoir 46.

Further, to help facilitate liquid transfer from the porous region to the capillary tubes 66, in some implementations, the porous region of the substrate 62 and capillary tubes 66 are configured such that liquid preferentially flows into the capillary tubes 66 from the porous region. For example, the diameter of the capillary tubes 66 may be set to be smaller than the (average) pore size of the porous region. Alternatively, features such as the relative smoothness or evenness of the surface of the capillary tubes 66 (which may otherwise be referred to as the contact angle) may also exhibit a preference for the liquid to flow along the capillary tubes 66.

Thus, what has been described is a heater assembly 6 for an aerosol provision system 1, comprising a substrate 62 and an electrically resistive layer 64 provided on a first surface of the substrate. One of more capillary tubes 66 extending from another surface of the substrate 62 (e.g., the surface opposite the first surface) through the electrically resistive layer 64 provided on the first surface of the substrate 62. The one or more capillary tubes 66 extend substantially linearly from the another surface of the substrate 62 through the electrically resistive layer 64 provided on the first surface of the substrate 62. The one or more capillary tubes 66 may be formed through a process such as laser drilling. The one of more capillary tubes 66 provide a direct pathway between the another surface of the substrate 62 and the electrically resistive layer 64. The one or more capillary tubes 66 may be formed such that each capillary tube 66 spans the shortest distance between the respective openings of the capillary tube 66. In this way, the capillary tubes 66 can be considered to enable an efficient transfer of liquid along the distance spanned by the capillary tubes 66. Additionally, the substrate 62 additionally comprises a porous region. The porous region is provided so as to supply liquid to the capillary tubes 66. This may be to facilitate transfer of liquid from one location of the heater assembly to another (e.g., to the capillary tubes 66) and/or to act as a buffer in the event the heater assembly is temporarily moved out of liquid contact with the liquid in the reservoir 46.

The heater assembly 6 as described above is generally provided as a relatively small component having a relatively small footprint (as compared to more traditional heater assemblies, such as a wick and coil). However, owing in part to the fact the capillary tubes 66 are formed via a manufacturing process in the heater assembly 6 (i.e., the capillary tubes are engineered), the heater assembly 6 can provide similar liquid delivery characteristics (and thus comparable aerosol formation characteristics) despite its relatively small size. That is to say, the heater assembly may provide more efficient wicking of liquid given that that diameter of the capillary tubes 66 can be selected/optimised for a given liquid to be vaporized and that the capillary tubes 66 are formed to follow substantially linear paths that directly deliver the liquid to the electrically resistive layer 64. By providing a smaller component, material wastage (e.g., when the cartomizer 3 is disposed of) can be reduced.

Not only can the liquid be provided more efficiently to the electrically resistive layer 64, but by manufacturing the capillary tubes 66, more control is given over the supply of liquid to the electrically resistive layer 64 (that is, the more capillary tubes of a certain diameter, the more liquid per unit time (ml/s) can be delivered to the electrically resistive layer 64).

Further, by including the porous region of the substrate 62, the feeding of liquid to the capillary tubes 66 can further be improved, as described above. Moreover, the heater assembly 6 is formed as a single component comprising both the substrate 62 (and porous region) in addition to the electrically resistive layer 64. This can help aid assembly of the cartomizer 3, particularly when the heater assembly 6 is manufactured to a small size.

In the example shown above, the end portions 68, 69 of the heater assembly 6 do not comprise capillary tubes 66. However, in some implementations, the end portions 68, 69 may also comprise capillary tubes 66. Depending on the specific configuration, the capillary tubes 66 in the end portions 68, 69 may be redundant in that the ends of capillary tubes 66 of the end portions 68, 69 do not contact the central opening of the upper clamping unit 5′ and thus are not in fluid communication with the reservoir 46.

It should be appreciated that the configuration of the cartomizer 3 accommodating the heater assembly 6 is provided as an example configuration of such a cartomizer 3. The principles of the present disclosure apply equally to other configurations of the cartomizer 3 (for example, comprising similar or different components to those as shown in Figure, and a similar or different layout to that shown in FIG. 2). Broadly speaking, a cartomizer is likely to comprise a top end (having the mouthpiece orifice 41) and a bottom end. In the examples shown above, the heater assembly 6 is arranged to be below the reservoir 46, substantially horizontal to the longitudinal axis of the cartomizer 3, and arranged in an airflow path that is substantially perpendicular to longitudinal axis of the heater assembly. However, this need not be case, and in other implementations the cartomizer 3 may be configured different depending on the particular design and application at hand. (For example, the heater assembly 6 may be arranged such that airflow is substantially parallel to the longitudinal axis of the heater assembly, e.g., along the exposed surface of the electrically resistive layer 64.)

In the example shown in FIG. 2, the contact pads 75 directly contact the electrically resistive layer 64 of the heater assembly 6. However, the cartomizer 3 may be provided with any suitable arrangement that facilitates the electrical contact between the aerosol provision device 2 and the heater assembly 6. For example, in some implementations, electrical wiring or other electrically conductive elements may extend between the electrically resistive layer 64 and the contact pads 75 of the cartomizer 3. This may particularly be the case when the heater assembly 6 has its largest dimension (e.g., its length) less than a minimum distance between the contact pads 75. The distance between the contact pads 75 may be dictated by the electrical contacts on the aerosol provision device 2.

FIG. 4 depicts, highly schematically, such an example of the heater assembly 106 coupled to electrically conductive contact elements. The heater assembly 106 comprises a substrate 162, an electrically resistive layer 164, capillary tubes 166 and end portions 168, 169 that are substantially identical to their counterparts described in FIG. 3.

The heater assembly 106 is shown as being coupled to electrically conductive contact elements 170 at either end of the heater assembly 106. This has the effect of increasing the footprint of the heater assembly 106, in situations for example when the heater assembly 106 has a longitudinal extent that is less than the separation between the contact pads 75.

The electrically conductive contact elements may be formed from any suitable conductive material (e.g., the same or different material that electrically resistive layer 164 is formed from). The electrically conductive contact elements 170 may be in the form of contact pads. The electrically conductive contact elements 170 are electrically connected to the electrically resistive layer 164, e.g., via suitable wiring or soldering, etc. It should be appreciated that the electrically conductive contact elements 170 are provided at a position relative to the heater assembly 106 so as to electrically couple the contact pads 75 to the electrically resistive layer 164 of the heater assembly 106. Accordingly, it should be appreciated that even when the heater assembly 106 itself does not have an adequate dimension/footprint that overlaps with the through holes 74, electrically conductive contact elements 170 can be provided to take account of the spacing stipulated by the placement of the contact pads 75.

Further, it should be appreciated that while FIG. 4 shows a vaporizer 106 in which electrically conductive contact elements 170 are provided at opposing longitudinal ends of the heater assembly 106, in other implementations, the electrically conductive contact elements may be formed by extensions of the electrically resistive layer 164. That is to say, rather than providing separate electrically conductive contact elements 170 that are subsequently electrically coupled to the heater assembly 106, the electrically resistive layer 164 may have a greater dimension in the longitudinal direction than the substrate 162. Put another way, the electrically resistive layer 164 (and in particular the end portions 168 and 169) may overhang the ends of the substrate 162. In these implementations, the extended ends of the electrically resistive layer 164 overlap the through holes 74 and provide contact with the contact pads 75.

Alternatively, to accommodate a different size heater assembly 6 that does not span the distance between the contact pads 75, the contact pads 75 of the cartomizer 3 may be modified (for example, the contact pads 75 are selected to be “L” shaped, providing a narrower distance at the point where the heater assembly contacts the contact pads 75).

In addition, in the described examples, the heater assembly 6 is orientated such that the electrically resistive layer 64 faces towards the bottom of the cartomizer 3. However, the orientation of the heater assembly 6 is not limited to this and, in other implementations, the heater assembly 6 may be provided in alternative orientations, for example, where the electrically resistive layer faces away from the bottom of the cartomizer 3.

In such implementations, the heater assembly 6 may be provided with electrically conductive elements that facilitate the electrical coupling of the contact pads 75 to the electrically resistive layer. In particular, the substrate may be made to be electrically conductive, at least in a specific region of the substrate.

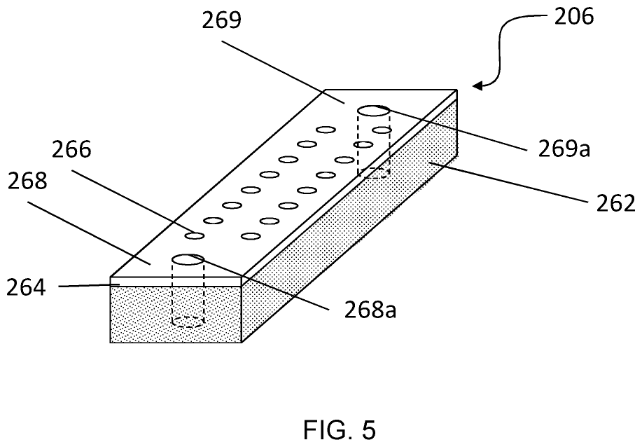

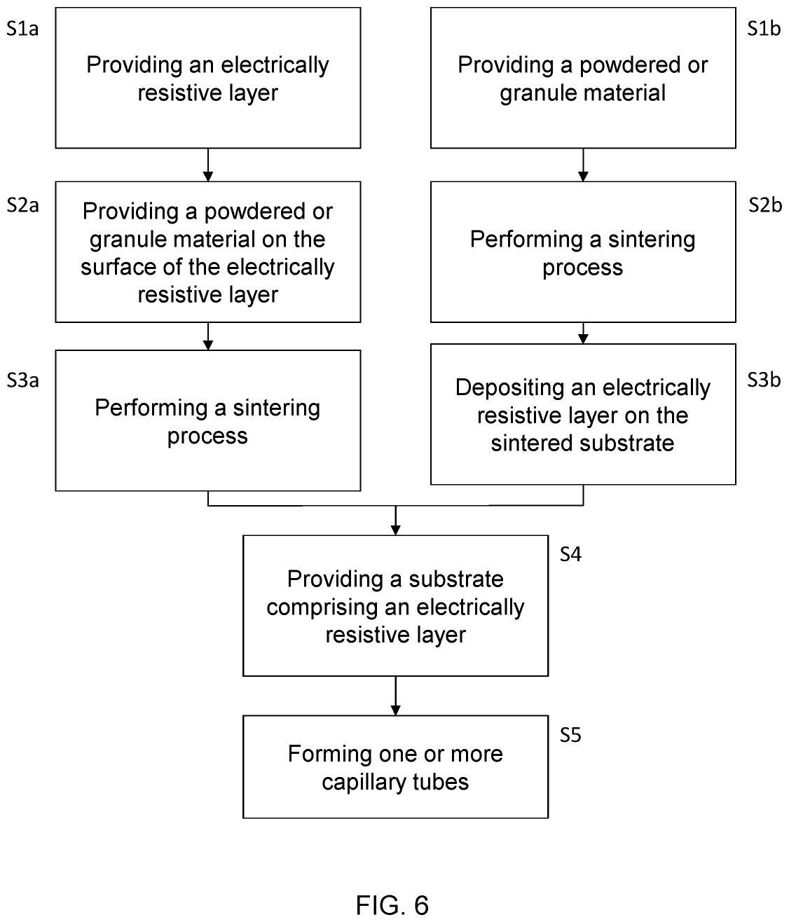

FIG. 5 depicts, highly schematically, such an example of a heater assembly 206. The heater assembly 206 comprises a substrate 262, an electrically resistive layer 264, capillary tubes 266 and end portions 268, 269 that are substantially identical to their counterparts described in FIG. 3. Indeed, the heater assembly 206 is substantially identical to the heater assembly of FIG. 3, however, the end portions 268 and 269 are further provided with electrically conductive elements. More specifically, the electrically conductive elements are shown as vias 268a and 269a at respective end portions 268, 269 of the heater assembly 206, shown in phantom in FIG. 5.

The vias 268a, 269a extend from one side of the substrate 262 to the other side of the substrate 262 and may or may not also extend through the electrically resistive layer 264. In any case, the vias 268a, 269a are configured to provide an electrically conductive path between the underside (i.e., the side not visible in FIG. 5) of the substrate 262 and the electrically resistive layer 264. As above, the heater assembly 6 is capable of being orientated in the cartomizer 3 such that the electrically resistive layer 264 faces away from the bottom of the cartomizer 3. Accordingly, the contact pads 75 make electrical contact with the surface of the vias 268a, 269a opposite the electrically resistive layer 264. An electrical circuit may nonetheless be formed but, in this implementation, the current supplied by the contact pads 75 (from aerosol provision device 2) additionally passes through the vias 268a, 269a before passing through the electrically resistive layer 264.

It should also be appreciated that the vias 268a, 269a shown in FIG. 5 are one example of an electrically conductive element designed to electrically connect the electrically resistive layer 264 when the electrically resistive layer 264 is unable to directly contact the contact pads 75. In other implementations, the end portions 268, 269 of the heater assembly 206 may be coated in an electrically resistive material and/or electrical tracks may be provided on the outer surfaces of the substrate 262 such that an electrical path is formed around the outside surfaces of the substrate 262 and coupled to the electrically resistive layer 264. In other implementations, the substrate material 162 itself may include, locally at the end portions 268, 269 or entirely throughout the substrate 262, conductive elements (e.g., fibers/wires) that permit current to be applied to the underside of the heater assembly 206 and pass to the electrically resistive layer 264. Particularly when the substrate 262 is formed from a sintered material, the substrate 262 may be made electrically conductive by including electrically conductive powders or granules in the mixture of powders or granules that are to form the sintered substrate 262. That is to say, the sintered substrate 262 may have a distribution of electrically conductive elements throughout the substrate 262. Alternatively, electrically conductive elements such as wires, metal sheets or even the vias 268a, 269a may be provided as elements combined with the powders or granules that are to form the sintered substrate 262 (that is, the sintered substrate may be formed around the electrically conductive elements).

Accordingly, in such implementations, the flexibility of how to electrically couple the heater assembly to contact pads 75 (or any other power supplying element of the cartomizer) can be increased. As discussed, the electrical contact can be made from below the electrically resistive layer 264, but equally the contact may be made on the side faces of the heater assembly 206.

It should also be appreciated that when the heater assembly 206 is orientated such that the electrically resistive layer 264 faces away from the bottom of the cartomizer, the cartomizer may be adapted in order to supply liquid to the underside of the heater assembly 206. In some implementations, the reservoir 46 may be moved so as to sit beneath the heater assembly 206. In other implementations, a wicking element (or more generally a liquid transport element) may be provided to transport liquid from the reservoir 46 (which may be located above the heater assembly 206, as in cartomizer 3 of FIG. 2), to the underside of the heater assembly 206 (and more specifically to the porous region of the substrate 262).

The described implementations of the heater assembly 6, 106, 206 above are arranged such that end portions 68, 69, 168, 169, 268, 269 of the heater assembly 6, 106, 206 are provided in fluid communication with the liquid in the reservoir 46 of the cartomizer 3 (e.g., via wells 53 provided in the upper clamping unit). However, the principles of the present disclosure is not limited to such configurations.

For example, the heater assemblies 6, 106, 206 may be arranged such that the central portion 67, 167, 267 of the heater assemblies is provided in conjunction with a well or other outlet of the reservoir 46 of the cartomizer 3. That is to say, liquid is fed directly to the central portion 67, 167, 267 of the heater assemblies (and subsequently directly to the capillary tubes 66, 166, 266). In these examples, the porous region of the substrate 62, 162, 262 is still provided adjacent the capillary tubes so as to be able to supply liquid to the capillary tubes, but the lateral/horizontal motion of the liquid to the central portion 67, 167, 267 is less significant. In these cases, the main function of providing the porous region is to retain an amount of liquid in the heater assembly 6, 106, 206 when the heater assembly is no longer in fluid contact with the liquid in the reservoir 46. Additionally, it should be understood that the end portions 68, 69, 168, 169, 268, 269 of the heater assembly 6, 106, 206 are provided in this case for the purposes of mounting the heater assembly 6, 106, 206 in the cartomizer 3. Accordingly, in such implementations, the end portions 68, 69, 168, 169, 268, 269 of the heater assembly 6, 106, 206 may be omitted and an alternative arrangement for mounting the heater assembly is provided (such as, e.g., a recessed portion in the lower support unit 7 into which the heater assembly is pressed).

It should also be appreciated that while the above has described a cartomizer 3 which includes the heater assembly 6, 106, 206, in some implementations the heater assembly 6, 106, 206 may be provided in the aerosol provision device 2 itself. For example, the aerosol provision device 2 may comprise the heater assembly and a removable cartridge (containing a reservoir of liquid, such as reservoir 46). The heater assembly 6, 106, 206 is provided in fluid contact with the liquid in the cartridge (e.g., via a suitable wicking element or via another fluid transport mechanism). Alternatively, the aerosol provision device may include an integrated liquid storage area in addition to the heater assembly 6, 106, 206, which may be refillable with liquid. More broadly, the aerosol provision system (which encompasses a separable aerosol provision device and cartomizer/cartridge or an integrated aerosol provision device and cartridge) includes the heater assembly.

FIG. 5 depicts an examples method for manufacturing the heater assemblies 6, 106, 206. In fact, FIG. 5 represents two different approaches for forming the heater assemblies 6, 106, 206, each of which will be discussed herein. However, it should be appreciated that the method described in FIG. 5 is an example only, and other ways of manufacturing the heater assemblies 6, 106, 206 may be utilized in accordance with the principles of the present disclosure.

The method begins at either step S1a or step S1b. Taking the branch of step S1a first, the method starts at step S1a by providing an electrically resistive layer (such as layers 64, 164, 264). The electrically resistive layer may be in the form of a sheet, and may be formed form any of the materials discussed above. In one implementation, the material may be titanium.

At step S2a, the method proceeds to provide a powdered or granule material. The powdered or granule material may be any suitable material used for forming the substrate 62, 162, 262 described above. In one implementation, the powdered or granule material is powdered quartz. According to step S2a, the powdered or granule material is placed on a surface of the electrically resistive material 64, 164, 264.

At step S3a, a sintering process is performed. As mentioned previously, the process of sintering involves exposing powdered or granule material to certain temperatures and impact (e.g., pressure) which causes the powdered or granule material to fuse together. Depending on the starting material, the parameters for sintering (e.g., temperature, pressure, time) may be suitably set.

In this particular implementation, with appropriate selection of the material of the electrically resistive layer at step S1a, powdered or granule material at step S2a, and the parameters of the sintering process, during the sintering process not only will the powdered/granules sinter together to form a bulk solid (having a pore structure), but the electrically resistive layer may form a bond with the sintered material. In other words, the sintering process of step S3a results in a unitary structure in which the electrically resistive layer is bonded to the sintered substrate. In some implementations, it may be necessary to include a material that aids the bonding, for example a resin or the like; however, if such material is used it should ideally have a melting/thermal decomposition temperature greater than the intended operating temperature of the heater assembly.

The method proceeds to step S4 where a (sintered) substrate comprising an electrically resistive layer is provided.

Turning to the branch starting at step S1b, the method here starts by providing the powdered or granule material. This may be the same material as used in step S2a. However, in this case, the powdered or granule material is provided in isolation of the electrically resistive layer. A suitable mould or die may receive the powdered or granule material.

At step S1b, a sintering process is performed. This is substantially similar to step S3a, except the electrically resistive layer is not provided.

Once the sintering process is complete, the method proceeds to step S3b where the electrically resistive layer is deposited on the sintered substrate. This may be as simple as attaching, in a suitable manner, the electrically resistive sheet discussed above in step S1a to the sintered substrate. In other implementations, this may involve a chemical or vapor deposition process to deposit the electrically resistive layer on the surface of the sintered substrate.

The method proceeds to step S4 where a (sintered) substrate comprising an electrically resistive layer is provided.

After step S4, the method proceeds to step S5, where the one or more capillary tubes are formed in the resulting (sintered) substrate comprising an electrically resistive layer. As described above, the capillary tubes 66, 166, 266 are formed through a suitable process, such as laser drilling. Accordingly, taking the (sintered) substrate comprising an electrically resistive layer, said (sintered) substrate comprising an electrically resistive layer is exposed to a suitable laser drilling process (e.g., subjecting the (sintered) substrate comprising an electrically resistive layer to a pulsed laser beam).

Thereafter, the resulting (sintered) substrate comprising an electrically resistive layer and capillary tubes may be formed into a heater assembly (e.g., by cutting or shaping into a suitable size), although this may not be required.

Thus, there has been described a heater assembly for an aerosol provision system, the heater assembly including a substrate; an electrically resistive layer provided on a first surface of the substrate; and one or more capillary tubes extending from another surface of the substrate through the electrically resistive layer provided on the first surface of the substrate. The one or more capillary tubes extend substantially linearly from the another surface of the substrate through the electrically resistive layer provided on the first surface of the substrate, and the substrate additionally comprises a porous region. Also described is a cartomizer including a heater assembly, an aerosol provision system comprising a heater assembly, and a method of manufacturing a heater assembly.

While the above described embodiments have in some respects focussed on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A heater assembly for an aerosol provision system, the heater assembly comprising:
a substrate;
an electrically resistive layer provided on a first surface of the substrate; and
one or more capillary tubes extending from another surface of the substrate through the electrically resistive layer provided on the first surface of the substrate,
wherein the one or more capillary tubes extend substantially linearly from the another surface of the substrate through the electrically resistive layer provided on the first surface of the substrate, and
wherein the substrate additionally comprises a porous region.

2. The heater assembly of claim 1, wherein the porous region is formed from one of: a naturally porous material or an engineered porous material.

3. The heater assembly of claim 2, wherein the substrate, including the porous region, is formed from one of: a naturally porous material or an engineered porous material.

4. The heater assembly of claim 1, wherein the substrate is formed from a sintered material, such as sintered quartz.

5. The heater assembly of claim 1, wherein the one or more capillary tubes extend through the porous region.

6. The heater assembly of claim 1, wherein the porous region is configured to absorb liquid aerosol-generating material.

7. The heater assembly of claim 6, wherein the porous region is further configured to supply liquid aerosol-generating material to the one or more capillary tubes.

8. The heater assembly of claim 1, wherein the one or more capillary tubes have a diameter in the range of 10 to 100 μm.

9. The heater assembly of claim 1, wherein the one or more capillary tubes are formed by laser drilling.

10. The heater assembly of claim 1, wherein the porous region comprises interconnected pores defining passages that follow a substantially random pathway through the porous region of the substrate.

11. The heater assembly of claim 1, wherein the pore size is between 1 to 100 μm.

12. The heater assembly of claim 1, wherein the substrate further comprises one or more electrically conductive elements.

13. A cartomizer for use with an aerosol-generating device for generating aerosol from an aerosol-generating material, the cartomizer comprising:
a reservoir for storing aerosol-generating material, and
a heater assembly according to claim 1, wherein the heater assembly is provided in fluid communication with the reservoir.

14. An aerosol provision system for generating aerosol from an aerosol-generating material, the aerosol provision system comprising the heater assembly of claim 1.

15. The aerosol provision system of claim 14, the system comprising an aerosol provision device and a cartomizer, the cartomizer comprising:
a reservoir for storing aerosol-generating material, and
the heater assembly,
wherein the heater assembly is provided in fluid communication with the reservoir, and
wherein the cartomiser is releasably connectable to the aerosol provision device.

16. A method of manufacturing a heater assembly for an aerosol provision system, the method comprising:
providing a substrate comprising an electrically resistive layer provided on a first surface of the substrate; and
forming one or more capillary tubes extending from another surface of the substrate through the electrically resistive layer provided on the first surface of the substrate,
wherein the one or more capillary tubes extend substantially linearly from the another surface of the substrate through the electrically resistive layer provided on the first surface of the substrate, and
wherein the substrate additionally comprises a porous region.

17. The method of claim 16, wherein providing a substrate comprising an electrically resistive layer provided on a first surface of the substrate includes:
providing an electrically resistive layer,
providing powdered or granule material on a surface of the electrically resistive layer, and
sintering the powdered or granule material to form the substrate.

18. The method of claim 16, wherein providing a substrate comprising an electrically resistive layer provided on a first surface of the substrate includes:
providing powered powdered or granule material,
sintering the powdered or granule material to form the substrate, and
depositing the electrically resistive layer on a surface of the sintered substrate.

19. Heater means for an aerosol provision system, the heater means comprising:
a substrate;
an electrically resistive layer provided on a first surface of the substrate; and
capillary means extending from another surface of the substrate through the electrically resistive layer provided on the first surface of the substrate,
wherein the capillary means extend substantially linearly from the another surface of the substrate through the electrically resistive layer provided on the first surface of the substrate, and
wherein the substrate additionally comprises a porous region.
